(19) United States
(12) Patent Application Publication
(10) Pub. No.: US 2012/0210840 A1
(43) Pub. Date: Aug. 23, 2012

(54) Window shade/fabric cut down tool

(76) Inventor: John Houle, Redwood City, CA (US)

(21) Appl. No.: 13/385,582

(22) Filed: Jan. 10, 2011

(51) Int. Cl. B26D 1/157; B26D 7/01

(52) U.S. Cl. 83/467.1

(57) ABSTRACT

A rotary cutting blade displaced laterally on an adjustable guide beam for cutting vinyl, mylar, or other window treatment material to a desired width and which permits trimming along any length of said material where it may be continuously fed through the present device and the last cutting point reset to permit additional cutting or trimming. A rugged structure comprising a base portion to which a pair of rail arms connected by a guide beam cross member portion is pivotally and adjustably attached. A rotary blade housing body that is simple and inexpensive to manufacture and allows for safe use.

### CROSS REFERENCE TO RELATED APPLICATIONS

This Nonprovisional Application is a conversion of Provisional Application: 61/460,930.

### STATEMENT REGARDING FEDERALLY SPONSORED RESEARCH OR DEVELOPMENT

Not Applicable.

### BACKGROUND OF THE INVENTION

1. Field of the Invention

The present invention relates to window covering material trimming devices.

2. Description of Related Art

The related art includes vinyl cutters, fabric cutters, paper cutters, and other cutters designed for trimming and/or cutting appropriate materials using a cutter base and a guided cutting means, as opposed to strictly handheld devices. Similarly, the related art includes cutting means that use a rotary blade.

### SUMMARY OF THE INVENTION

A first feature of the present invention is characterized in that a window covering material trimmer wherein a rotary cutter displaces along a guide beam and material trimming is carried out by rolling a rotary blade supported by a cylindrical rotary cutter body outer edge, the rotary cutter is divided into a rotary blade supporting body and a guide member, the rotary blade supporting body may be provided with a sliding surface which may be supported by bearings or other friction reducing means and further comprises a protruding lip at the rotary blade end that covers over the circumferential edge of the rotary blade except for a bottom portion where the rotary blade bottom edge extends below the flat bottom of the rotary blade supporting body.

A second feature of the present invention is characterized in that the above rotary cutter body outer edge comprising the protruding lip portion is displaced proximally to a vertical surface along the rotary cutter displacement travel length so as to provide a safe method for cutting or trimming.

A third feature of the present invention is characterized in that the above rotary cutter is supported by a guide rail attached to vertically adjustable rail arms such that a roll of material of any length can be fed through the present invention so as to cut or trim the entire length of said roll of material.

The characteristics and utilities of the present invention described in this summary and the detailed description below are not all inclusive. Many additional features and advantages will be apparent to one of ordinary skill in the art given the following drawings, specifications and claims. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, by explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a purpose of the present invention to cut or trim materials used in window covering materials including but not limited to vinyl sheeting, fabrics, polymer, wood including bamboo, and/or mylar.

It is therefore a purpose of the present invention to comprise a durable structure made principally from aluminum or similar material that can be bonded or welded sufficiently whereby the present invention can withstand use by those in the construction trade for an extended number of years of regular use.

It is therefore a purpose of the present invention to provide a rotary cutting tool with an easily replaceable and/or inexpensive rotary blade.

It is therefore a purpose of the present invention to provide an easily manufactured rotary cutting tool body including but not limited to injection molding, stamping, or similar means for producing structures made of polymer, elastomer, and/or other materials made from a die.

It is therefore a purpose of the present invention to provide a rotary cutting tool that is safe to use.

It is therefore a purpose of the present invention to permit trimming of a roll or section of material of any length.

### (BRIEF) DESCRIPTION OF THE DRAWINGS

The present invention may be better understood, and its numerous features and advantages made apparent to those skilled in the art by referencing the accompanying drawings. For ease of understanding and simplicity, common numbering of elements within the illustrations is employed to identify an element in the different drawings.

FIG. 1 is: an exploded view of the base portion, the cutting arm, and the acrylic base; bolt and nut attachment means are shown at the rail attachment point that connects the cutting arm to the base portion.

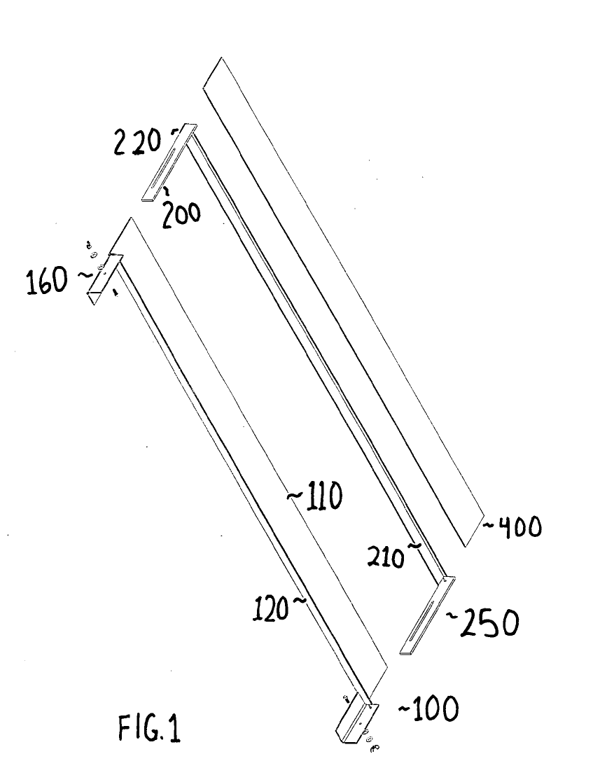

FIG. 2 is: a plain view of the present invention showing how a section of vinyl sheeting is placed for trimming on the acrylic base and held in place by the bottom edge of the cutting arm cross member with the cutting arm rail portion removed for illustrative purposes; the rotary cutter is shown as positioned in use with the rotary blade used to bisect a portion of the vinyl.

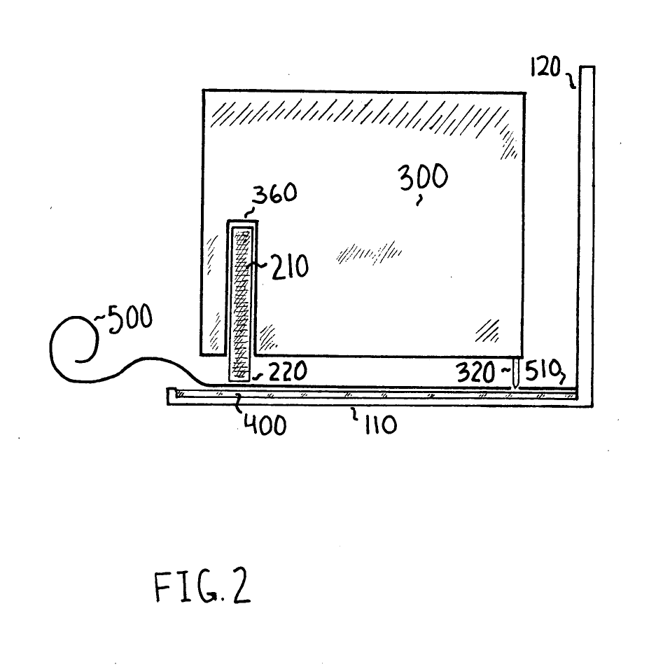

FIG. 3 is: a perspective view of the rotary cutter as placed on the guide beam and positioned for use as in use with a gripping means on the bottom of the guide beam comprising a large perpendicular surface; cutting arm rail portions are not shown.

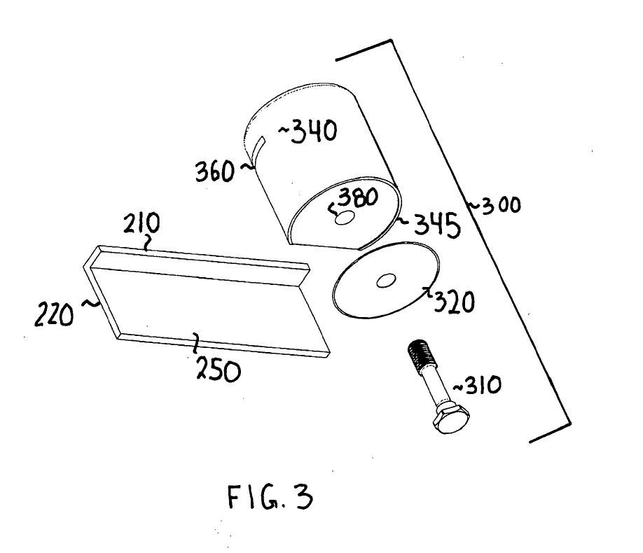

### DETAILED DESCRIPTION

The general purpose of the foregoing application is to describe a device for cutting window covering material including but not limited to vinyl sheeting, mylar sheeting, and/or any material that could be trimmed or reliably pierced to create a straight edge by the rotary cutting means disclosed in the present invention. A generally planar two-piece structure comprising a parallel pair of laterally adjustable vertical rail portions 200 separated by a separate pair of independent parallel planar and vertical cross-member portions 210, 120 situated over a planar base portion 110. Said vertical rail portions share a common axis of attachment 160 allowing forward-backward adjustment and up-down adjustment by manipulating the outer vertical cross-member herein referred to as the guide beam 210; said rail portions 200 and guide beam 210 together comprising the cutting arm 250. The inner vertical cross-member 120 and a horizontal base portion 110 are perpendicularly affixed together along their respective lengths; extending away from the base on the opposite side of the inner vertical cross-member are a parallel pair of L-shaped rail holding plates 140 at opposite ends of the base portion each with a corresponding fixed rail attachment point 160 forming a linear axis between each of said plates 140 around which said vertical rail portions and guide beam are manipulated. Together the L-shaped rail holding plates, the base portion, and the inner vertical cross-member form the base portion 100. A rotary cutting tool 300 comprising a generally cylindrical cutter body 340 with a flat bottom portion 305, a rotary blade 320 with a threaded central orifice portion 380 at a terminal end of the cutter body, a shoulder bolt 310 or similar rotary blade attachment means with corresponding threads to those in said cutter body 380, and a guide groove 360 generally comprising a rectilinear opening or slot in the cutter body situated parallel to the planar surface of the terminally situated rotary blade and is selectably inserted over the correspondingly rectilinear top edge of said guide beam. An acrylic or similar planar cutting surface 400 placed over said base portion so as to permit material penetration while minimizing rotary blade edge degradation.

The advantages to a rotary blade for the cutting or trimming of sheets of material including paper are well known to the art. A rotary blade enables use of a device with a guide bar means where lateral displacement of a slidable housing preferably employs a rotary blade. The present invention improves on the current art however with a rotary blade located on the exterior surface of a slidable housing which makes for easy replacement of the rotary blade as opposed to a blade positioned inside of a housing. Safe use of the rotary blade in the present invention is ensured where in use the rotary blade exterior side is adjacent to the vertical base housing cross-member and the majority of the rotary blade edge is covered by a curved protruding lip portion 345 that extends past the end of the cutter housing body and over the rotary blade edge. The rotary blade diameter is therefore preferably smaller than the cutter housing body diameter to permit said lip portion and to permit optimal hand and finger or thumb placement proximal to the rotary blade during lateral displacement.

In use, material to be trimmed 500 is pinned between the bottom of the cutting arm gripping means portion 220 and the base with the edge of the material placed proximally along the side of the vertical base housing cross-member. The cutting arm is adjusted front-back using the adjustable rail portions so that the rotary cutter and the rotary blade can be displaced laterally along the material sheet side edge by a predetermined distance where the present invention can reliably remove as little as one-eight of an inch of material along said material side edge. Where the interior surface of the vertical rail portions act as stop-guides for the rotary cutter, said sheeting front edge is generally placed somewhere between said vertical rail portions so that a strip 510 is typically formed after a cut that is still attached to the sheeting where the cutter lateral displacement was stopped along the sheet side edge. Said strip may be removed using a scissor or other cutting means and the material 500 repositioned so that lateral displacement of the cutter may resume proximally to the point where it ended in the prior cut.

The previous is a detailed description of illustrative embodiments of the present invention. As these embodiments of the present invention are described with references to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense, as it is understood that the present invention is in no way limited to the embodiments illustrated.

A window covering materials cutter, comprising:

What is claimed is:

1. A rotary blade; a rotary blade housing body; a base portion; a cutting surface; and a cutting arm wherein:
said rotary blade housing body is of appropriate shape and structure to permit a portion of an affixed rotary blade to extend below the bottom surface of the rotary blade housing body;
said rotary blade is affixed to the cutting end of said rotary blade housing body such that the rotary blade may be permitted to turn when the housing body is laterally displaced along a guide beam portion of said cutting arm;
said rotary blade housing body cutting end comprises a lip portion extending past the circumferential edge of said rotary blade excluding the portion of the rotary blade extending below the bottom surface of the rotary blade housing body;
said rotary blade housing body further comprises a guide groove portion comprising a slot opening of an appropriate shape to permit placement over said guide beam portion and to permit lateral displacement of the rotary blade housing body along the guide beam portion;
said guide beam portion of said cutting arm may further comprise a frictional bottom surface whereby in addition to frictional force applied to the cutting arm during lateral displacement of said rotary blade housing body and thereby on the material being cut, a surface preparation of or appropriate material applied to said bottom surface may be used so as to further cause material being cut to remain in place during cutting;
said cutting arm is comprised generally of two parallel rail arms and a connecting cross member that comprises said guide beam portion, wherein:
said rail arms are each connected to the base portion via pivot points located on an axis shared by both rail arms; and
a means for adjusting said pivot point location on each of said rail arms permits displacement of said guide beam out a desired generally equal distance from each pivot point so as permit trimming of a desired amount of material;
and said base portion comprises:
a horizontal surface upon which said cutting surface is placed and whereby said cutting surface may be comprised of a material derived from acrylic acid;
a vertical surface perpendicularly affixed to said horizontal surface and which acts as a stop point at which a side of a length of material is placed against for guide beam displacement measuring and for straight cutting; and
a pair of bracketing means on the opposite side of said vertical surface, and at opposite ends of said vertical surface, comprising a means for stabilizing the structure and a means for supporting said pivot points.
